(19) United States
(12) Patent Application Publication
(10) Pub. No.: US 2003/0097383 A1
(43) Pub. Date: May 22, 2003

(54) Enterprise privacy system

(76) Inventors: Alexis Smirnov, Montreal (CA); Roger McFarlane, Montreal (CA)

Correspondence Address: FASKEN MARTINEAU DuMOULIN LLP, Suite 4200, Toronto Dominion Bank Tower, P.O. Box 20, Toronto, ON, M5K 1N6, CA

(21) Appl. No.: 10/116,121

(22) Filed: Apr. 5, 2002

(30) Foreign Application Priority Data
Apr. 5, 2001 (CA) 2,343,263

(51) Int. Cl. G06F 12/00

(52) U.S. Cl. 707/204

(57) ABSTRACT

A method for creating a structured privacy policy the method comprising the steps of accessing a database containing data to be privatized; determining for specified data how that data is to be shared; and generating an XML based document describing how the data is to be shared, the document defining the privacy policy.

The present invention relates to a system and method for managing privacy policies, and more particularly to a system and method which includes creating and implementing a structured privacy policy in an enterprise.

### BACKGROUND OF THE INVENTION

Privacy has become a pressing operational issue for businesses, and many have already begun re-engineering their information systems and data-handling practices to deal with the issue effectively and efficiently.

Organizations are making mistakes regards the release of information because they have policies, but no tools to ensure that their IT systems are aware of those policies. For example, a hospital recently released a list of organ donor names to transplant recipients. The policy of not revealing that information was well known to employees, but not their computers.

Organizations are changing their policies and coming under fire because they don't know what they're committing to when they write their policies. Several well known companies have come under fire in the last weeks for changing their policies for reasons that should have been predictable when those policies were created.

Corporate privacy programs and infrastructures can be said to evolve over five stages, as outlined in Table I below.

TABLE I

| | |
|---|---|
| Policy | In response to external stimuli (complaints, news |
| development | articles, lawsuits, regulations) companies conduct a |
| | high-level risk assessment and develop and publish a |
| | privacy policy. |
| Data handling | In anticipation of assessing compliance, the company |
| assessment | takes inventory of what data it collects and how that |
| | data is handled and shared with third parties. Given a |
| | set of policies and a map of how data is collected and |
| | shared, the company assesses conflicts between stated |
| | policy and actual practice. |
| Compliance and | The company reconfigures and/or upgrades its IT |
| risk assessment | infrastructure to automatically enforce privacy policies. |
| Enforcement | All attempted transactions are monitored for |
| | compliance to policy; policies, practices, and |
| | infrastructure is updated as business changes. |
| Monitoring and | |
| auditing | |

It is thus desirable for an enterprise privacy management system to fulfill the following goals. Firstly, privacy policies must be structured. Text cannot be read and understood by enterprise data applications, privacy policies should be expressed in a machine-readable form. Once machine-readable, policies can be easily catalogued, updated, modified, and referenced for audit and assessment purposes. XML (extensible markup language) has quickly emerged as the universal format for data interchange and is therefore the most suitable.

Secondly, data-handling practices must also be structured. Today, most companies struggle with ways to best track and understand their data-handling practices. The sheer magnitude of this task makes the need for formal models even more apparent. To evaluate its own compliance with stated policies, a company must ask itself a series of questions: Do any of our current business activities violate the company's privacy policy? Will any planned or proposed activities violate policy? If a new policy is to be introduced, which departments and programs will be impacted? If a new regulation is passed, which policies will need to be modified? Which practices? Modeled together, for true gap analysis or potential conflict identification to be possible.

Thirdly, privacy tools must incorporate privacy intelligence. The automation of privacy enforcement will raise the stakes significantly for authors of policy, since the policy that will be created will be consumed automatically by mission-critical applications. Before a policy can be pressed into service, several issues must be resolved: Are all of the parts consistent with each other? Do they overlap or conflict with one another? Have the desired (and required) business practices been tested against policy prior to “going live” with the policy? Are the policies consistent with relevant external regulations, contractual obligations, and industry guidelines? It is important to note that privacy introduces a set of concepts like customer notification, customer permission, and purpose of data use that have not yet been addressed by other types of “policy” tools, such as network access control. Effective tools to create digital privacy policy can only be developed by marrying both technical and privacy policy expertise.

There is thus a need for a method and system, which mitigates at least one or more of the above problems.

### SUMMARY OF THE INVENTION

A method for creating a structured privacy policy the method comprising the steps of accessing a database containing data to be privatized; determining for specified data how that data is to be shared; and generating an XML based document describing how the data is to be shared, the document defining the privacy policy.

### BRIEF DESCRIPTION OF THE DRAWINGS

These and other features of the preferred embodiments of the invention will become more apparent in the following detailed description in which reference is made to the appended drawings wherein:

FIG. 1 is schematic diagram of a policy model structure;

FIG. 2 is a tree diagram showing relationships between actors;

FIG. 3 is a block diagram of an EPM system according to an embodiment of the present invention;

FIG. 4 is a schematic diagram showing software architecture of a PRM console according to an embodiment of the present invention;

FIG. 5 shows the console client server exchange of messages;

FIGS. 6-7 shows UML static diagrams for the PRML.

### DETAILED DESCRIPTION OF THE PREFERRED EMBODIMENTS

In the following description like numerals refer to like structures in the drawings.

The following is a list of acronyms used in this description.

| Acronym | Description |
|---|---|
| EPM | Enterprise Privacy Manager |
| PI | Personally Information |
| DBA | Database Administrator |
| PA | Privacy Administrator |
| CPO | Chief Privacy Officer |

1. Basic Concepts

The following defines basic concepts and terminology used in describing the Enterprise Privacy Management system of the present invention.

1.1 Frameworks

The EPM framework provides the building blocks for developing a policy model. Frameworks are developed by domain experts prior to building a policy model.

A framework file consists of:

elements and element types

templates for statements

analysis rules

1.1.1 Element Types

Elements are the building blocks of an EPM policy model. There are five types of elements: Actor, Action, Data, Purpose, and Condition. These element types are used to classify elements.

1.1.1.1 Element

Elements are the basic building blocks of statements. An element is a noun or a verb (or a noun or verb phrase) used as part of a statement. For instance, the elements “Health Care Practitioner,” “Sell” and “All your personal data” could be used in the statement “A health care practitioner ma sell all your personal data.”Each element belongs to an element type.

1.1.1.2 Action Element

An Action element represents the processes carried out on a piece of data.

Example: create, read, update, delete

1.1.1.3 Actor Element

An Actor element represents entities (individuals or organizations) that interact with data.

Example: customer service representative, shipping center, bank.

1.1.1.4 Condition Element

A Condition element represents the restricting conditions under which an operation may be performed on a piece of data.

Example: if consent is given, if subject hasn't opted out.

1.1.1.5 Data Element

A Data element in the operational model represents pieces of information an enterprise uses, in the course of carrying out its operational procedures.

Example: home address, customer account, email address

1.1.1.6 Purpose Element

A Purpose element represents the reasons for which an Action element is performed on a Data element.

Example: targeted marketing, product update communication, special offer communication.

1.1.2 Templates

Templates may be thought of as the grammar that defines how the elements can be assembled in an EPM policy model statement. They are created by an expert who defines how to combine elements together into a meaningful fashion.

For example: A Practice template can be filled in to create a statement that an actor does (or does not) perform some action on some data for some purpose, provided that some conditions are satisfied. The data may not be associated with providers and/or recipients. Exceptions may apply to this statement.

1.1.3 Analysis Rules

Analysis rules are the third component of a framework, and together with element types and templates constitute a complete framework. Analysis rules are provided by an expert and allow EPM to analyze the relationships among the statements in an EPM policy model. The purpose of analysis rules is to generate analysis results which are descriptions of how statements are related.

1.2 Policy Model

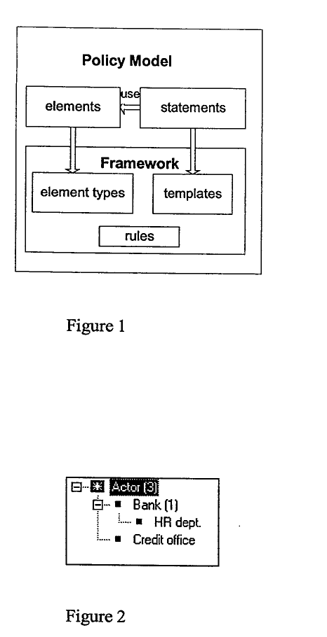

A policy model is also a file which is built by the privacy organization to represent the privacy policy and data-handling practices of an enterprise. An EPM policy model uses a framework as a foundation and is populated with elements and statements as shown in FIG. 1.

1.2.1 Elements

Elements are the building blocks of a policy model, representing each of the items in a privacy policy.

All elements may contain one or more child elements of the same element type. For example, an Actor element called ABC Bank may contain Marketing Department, which may contain Marketing Manager. It is also possible to build these types of child relationships among Action, Data, Purpose, and Condition elements.

1.2.2 Statements

A statement is built from a template by replacing the template slots with elements, and other statements. The result of this process is either a practice, principle, data combination or precedence statement.

A practice is a descriptive statement stating that something does or does not occur under some particular condition(s).

A principle is a prescriptive statement stating that, under some particular condition(s) something may or may not occur.

A precedence statement indicates that one statement has a higher precedence than another statement.

A data-combination statement provides information on how data can be combined and the affects of the meanings of combinations.

1.2.2.1 Practices

Practices are statements derived from the Practice template that describe the activities of an enterprise that are deemed to be relevant to consumer data privacy policy. An example of a practice statement is

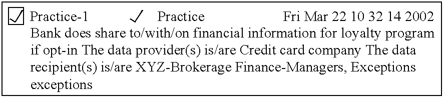

1.2.2.2 Principles

Principles are statements derived from the principle template that describe a privacy-related guideline that an enterprise wishes to follow in its day to day activities. An example of a principle statement is:

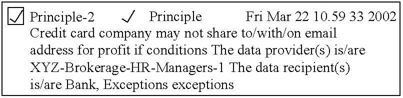

1.2.2.3 Scope

The concept of scope is useful for discussing the relationships among statements. Informally, a statement applies to elements that are within its scope, but does not apply to elements outside of its scope. The statement scope is measured as the elements contained in the statement along with the children of those elements, the children of children, etc. Conditions are not usually included in the measure of a statement's scope.

For example, given the Actor elements presented in FIG. 2, if a statement is created that contains Bank as the Actor, it will also include HR department in its scope, but not Credit Office.

1.2.2.4 Exceptions

A principle or practice statement may contain exceptions. An exception is a statement. It is intended to override all or part of the analysis results concerning its parent statement. It is possible for one statement to have multiple exceptions and/or to have exceptions to exceptions.

1.2.2.5 Precedence

Statements that contain some of the same elements may contradict one another. One way in which these contradictions can be resolved is by assigning precedence among overlapping statements.

Precedence can be represented with precedence statements or with exceptions. A statement with higher precedence can override another statement of lower precedence where the statements contradict one another. Similarly, an exception can override its statement where the exception contradicts its statement.

1.2.3 Filters

A filter can be applied to any element in a statement to reduce the scope of the statement. The statement will apply only to the children of the element, which satisfy the filter's criteria. A criterion is the presence or lack of a particular piece of text in a particular property of an element.

Building a policy model means defining elements and creating statements from the templates. Once the policy model is created it is saved as a file.

2. System

2.1 Overview

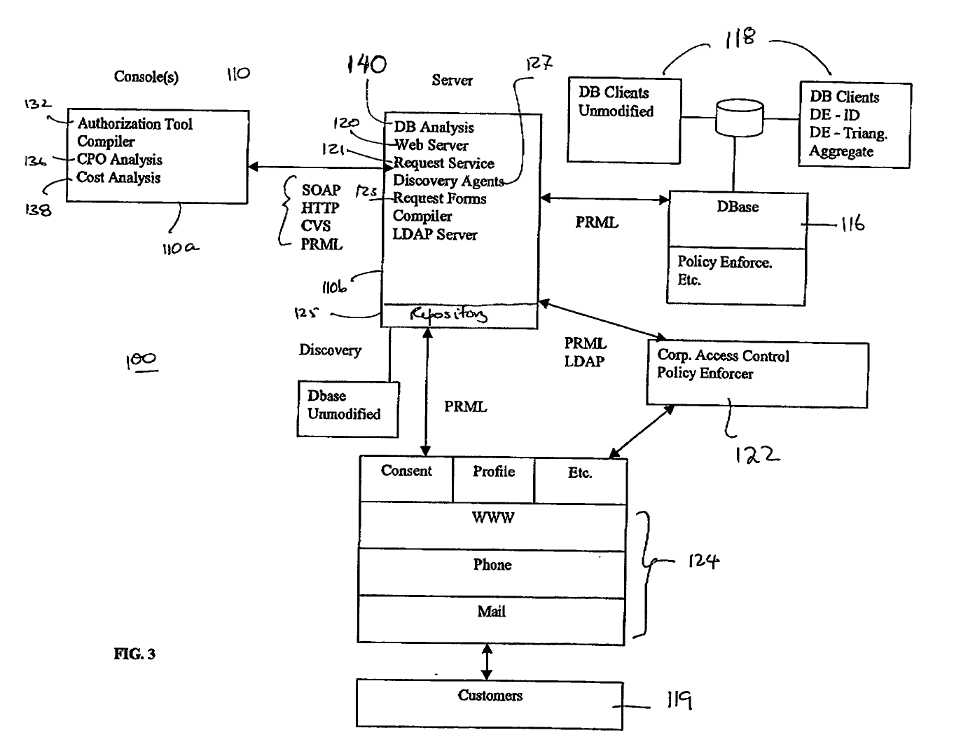

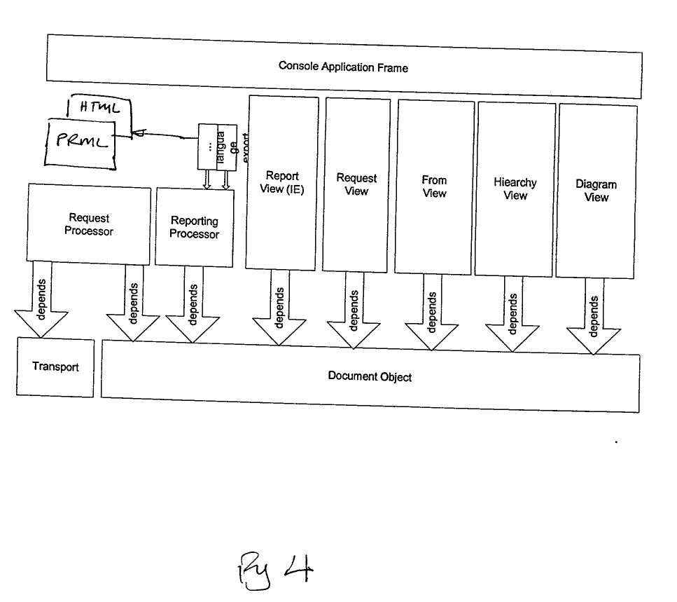

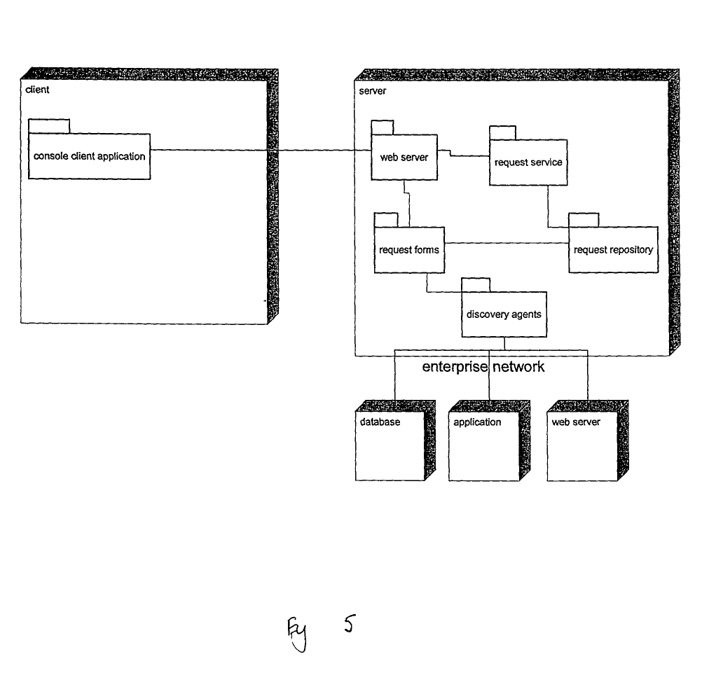

Referring to FIG. 3 here is shown a block diagram of an enterprise privacy management (EPM) system 100, according to an embodiment of the present invention. The system 100 includes core technology components, which enable the basic functionality of the privacy platform. Core technology is a mixture of running software components, specifications, APIs, and concepts. It does not require integration into enterprise systems, however, it can provide components and templates which are used to integrate other aspects of the privacy platform into an enterprise system.

The core technology includes a console 110, which provides a suite of tools for building, compiling, analyzing, deploying and managing an enterprise policy model. In the illustrated embodiment, the system 100 also includes a database 116 containing data to which the policy model is to be applied; a group of internal users 118 who access the database through the enterprises internal network and a group of external users 119 such as customers who access the database either through a corporate access control interface 122 or through one or more communications medium such as the internet, direct telephone access or mail 124. The users will fall into one or more of the groups depending on the enterprise application that is being used for example, customer-facing systems such as audit, preference, specialized applications; “back-end” systems such as transaction processing, billing, ERP, manufacturing; “front office” applications such as a customer relationship manager (CRM) and a “web office” such as web services or partner web sites.

Each of the components will be discussed in detail below.

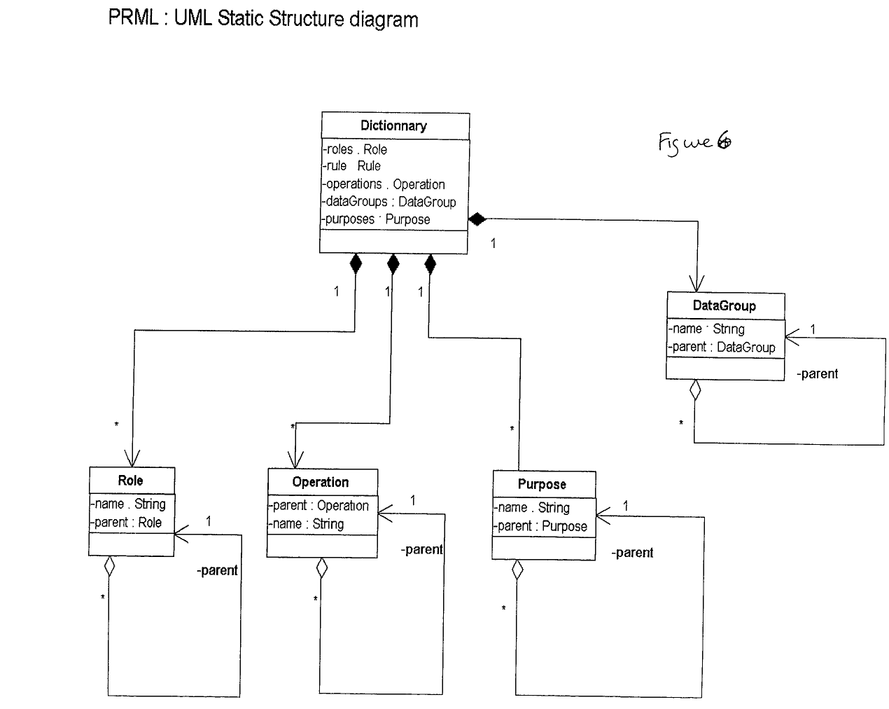

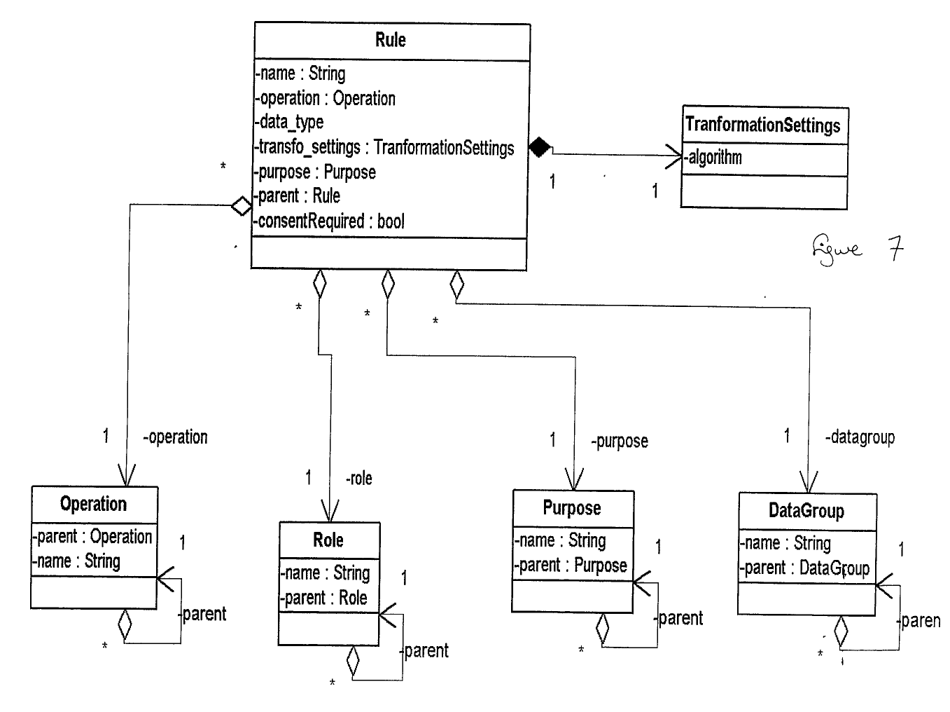

Referring to FIG. 4 there is shown the software architecture of the console. The console 110 is comprised of two sub systems, a client 110a and a server 110b. The console client 110a is a Windows application which implements all the user centric features of the console. The console client's internal data structure allows the modeling of relationships between data subjects, data items, roles, privacy principles, as described under section 1 above. Based on this data model, reports are generated.

The console server 110b provides support for integrity, collaboration, discovery and distribution. The console server responds to information queries called “requests” from the one or more console clients 110a. The console server includes a web server 120, a request service 121, request forms 123, a request repository 125, and discovery agents 127. The web server provides basic HTTP protocol support to the request service. All communication between console clients 110a and the request service 121 is via HTTP using SOAP (Simple Object Access Protocol). The web server 120 hosts web forms, servlets and scripts to provide a UI for fulfillment of the request from the console clients.

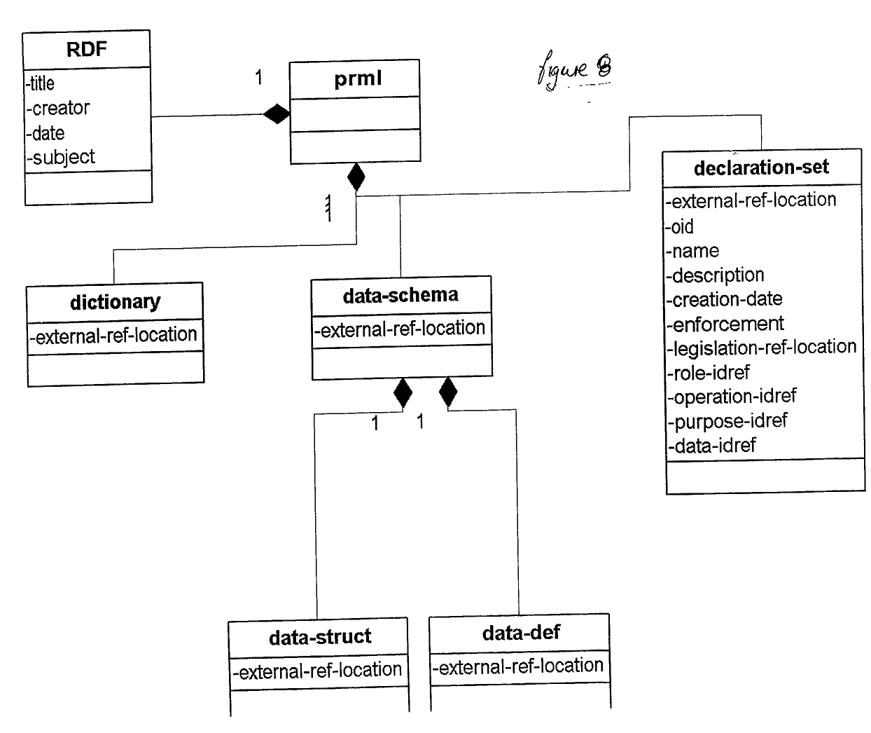

Referring to FIG. 5 there is shown a flow of requests between the console client and server. In use, the console client sends a request for specific information, such as details about what data is contained in a particular database, to a request service in the EPM server. The request service processes the requests sent by the client and directs the request to the intended recipient. The request is stored in the server-side repository. When the recipient completes the request, the results are also stored in the repository. The result is forwarded to the console client where it is integrated with the client's data set.

The request service may also direct the request to another user if so desired. Similarly the request may be directed to a discovery service. In this case the discovery service runs the process on some target system such as a database, web server or directory server. Once again the completed request result is stored in the repository. The discovery service can also expose its interface to request recipients

As may be seen the request service is the core of the console server. This component listens for the client calls via HTTP and responds accordingly. The main communications between a client and the server include: (a) the client sending a new request to the service; (b) the Client enumerates all requests that match certain criteria (for example: “give me all uncompleted requests”). Discovery services are J2EE-based applications. Each service includes its own web-based UI, the discovery and persistence logic.

The console client and the console server may use a variety of protocols to communicate, including SOAP and a version control protocol, such as CVS (concurrent versioning system). SOAP is a lightweight protocol for exchange of information in a decentralized, distributed environment. It is an XML based protocol that consists of three parts: an envelope that defines a framework for describing what is in a message and how to process it, a set of encoding rules for expressing instances of application-defined datatypes, and a convention for representing remote procedure calls and responses. CVS provides support for document version management activity. Those activities include putting files into a repository, getting files, making changes to them, and committing those changes to one or more branches. All of these facilities are available to one or more users on one or more hosts. It also offers management interfaces that allow examination of the history and content of file creation, modification, and deletion; comparisons between arbitrary file versions by date, author, or version; security and access control around each of these facilities; and management facilities for the import and export of files into different repositories.

Version control also provides the underpinnings of collaboration; the technical abilities to have more than one person working on a policy a time, and track the changes each one makes to it, for reconciliation. These features allow a CPO to delegate parts of their policy work to others. For example, a team working in Europe could take responsibility for crafting policies that will fall under European regulation, while another team could focus on the practices of the customer service organization. The policies could then be brought together, synchronized, and checked for consistency.

As mentioned above the privacy model describes how data can be accessed and how it should be transformed given attributes of the request/requestor, such as role, purpose, and operation applied on the data.

There is a need to provides an efficient mechanism to coordinate corporate privacy policies with access control policies. At present a set of costly processes is necessary to assure that the two policies are consistently coordinated. The present invention provides a solution by providing a language for defining the data exchange called “privacy rights markup language” PRML which provides a standardized mechanism for the components to communicate with each other.

The console server distributes information about how to implement a privacy policy to a variety of systems (back-end, front-office, web-office) through a variety of mechanisms (directory, web server), both push and pull based, using the PRML markup language. The preferred pull mechanism is using SOAP; the preferred push mechanisms are via HTTP POST and push to a directory, such as LDAP.

2.2 Console Client Components

2.2.1 PRML Authoring Tool (132)

The console client includes an PRML authoring tool, as a basic utility, which facilitates the creation of PRML policies. It allows a user to describe her organization's privacy and data handling practices and render them as a set of PRML documents which can be passed to the PRML compiler or to PRML aware software components which can then act on the policy.

2.2.2 PRML Compiler and Tool Suite

The PRML compiler provides complex analysis of a PRML policy. It computes all implied statements within the policy, fully describes a role, identifies how specific data items can be manipulated and by whom. The compiler is used to make a policy completely explicit so that a PRML aware component does not need to do extensive computation in order to apply that policy to its functions.

2.2.3 Tools

The tools provide analysis and control functions for the privacy framework. They allow a user to analyze their databases, data flow, policies, etc and obtain information regarding the consequences of the decisions which they maker regarding their systems. The tools are linked to the core technology to leverage the analysis capabilities of the core and to allow the tools to control PRML enabled components. In the general case, tools can be stand-alone applications, which can be run any user without any systems integration. On their own, the tools can provide analysis and simulation results. For example, the CPO analysis tool could provide information regarding a policy's ability to enforce some privacy legislation but would not be able to enforce it without the underlying framework.

2.2.3.1 CPO Analysis (136)

The CPO analysis tool allows a user to describe an organization's data handling policy for personal information and provide information regarding the implications of the policy. The tool can describe in detail the access which is actually granted to certain roles, how specific types of data can be manipulated, etc

2.2.3.2 Policy Analysis

This tool takes a PRML privacy policy and provides information regarding all its dimensions.

2.2.3.3 Cost Analysis (138)

This tool can provide a performance analysis for the policy when it is applied to various PRML aware components. It will be able to determine if it would be efficient or not to run it against a database system, the load on a de-identification engine, etc.

2.3 Console—Server

The console server includes a web server 120, a request service 121, request forms 123, a request repository 125, and discovery agents 127.

2.3.1 Database Analysis (140)

This tool will scan a database system and provide a data schema. It can analyze this schema and identify potentially sensitive information. ps 2.3.2 Collaboration Server

The collaboration server contains a repository of documents under revision control. When the users change documents, the collaboration server compares the new version to the antecedent, notes changes, and places the new version in the appropriate branch. It may also notify other users that files have changed. It provides comparisons relative to the appropriate branch to the versions of documents on which those other users are working.

2.3.3 Web Server

The web server acts as an interface for those users who do not have a console installed. It manages requests sent to those users for collaboration and assistance, and has a set of forms held in a repository to serve that purpose. The web server also acts as a distribution point for PRML files to others systems within the organization.

2.3.4 Discovery Server

Discovery of various databases can be a long, slow process. It may not complete if started from a console on a laptop, or other machine, which is not reliably connected. As such, consoles send discovery requests to a server, which has discovery agents that carry out discovery tasks, and then respond to the requesting client.

2.3.5 Access Control Server

This tool provides either an access control list to manage who can access what portions of the data contained within the server, or brokers requests to a corporate access control server which contains such data.

2.4 Engines and Modules

Engines provide extensive functionality. These are designed to provide services across an enterprise's system. These components require extensive modification to integrate into a customer's system or systems. Modules provide a certain type of functionality, which is used to augment the services provided by the privacy platform once installed at a customer site. These components are essentially complete system, which require few if any modifications in order to be integrated. They can function on their own, be integrated into our privacy platform or another vendor's platform

2.4.1 Policy Enforcement

This engine enforces a privacy policy within an enterprise's data systems. It will commonly be linked into a database system to provide privacy based access control to applications.

2.4.2 De-Identification

The de-identification engine breaks the link between an individual and a set of information. Once broken, the link cannot be remade.

2.4.3 De-Triangulation

The de-triangulation engine ensures that for any query that can be made to a data set, a minimum number of responses is returned. Restricting the queries themselves can do this or (preferably) by ensuring that the data set itself does not contain information, which is explicit enough to make it the sole result of a search.

2.4.4 Aggregation

An aggregation engine pools a data set together in order to provide generalized information. It no longer contains information which can be linked back to an individual, and would probably not contain personal records at all.

2.4.5 Pseudonimity

A pseudonymity engine contains personal information records, however, they are linked to pseudonyms rather than real individuals. This allows the user of a pseudonimity engine to do fairly detailed analysis of his user base without actually identifying his users and allows the users to manipulate and update their records without identifying themselves.

2.4.6 Consent

This is a module which manages user consent for release and use of information. It has multiple interface points with a common API which allow a user to set her preferences. This could include voice over telephone, Internet, etc.

2.4.7 Profile Server

A server which manages user profiles and allows certain pieces of information to be released under the control of the subject of that information. This server is pseudonymous so that neither the operator of the server nor the applications which query it are aware of the true identity of a data subject.

2.4.8 De-Identification Layer

The de-identification layer allows for means by which data or groupings of data which can be used to identify an individual is exposed and assigned a risk factor. If the risk factor exceeds the threshold for a given situation, various scenarios can be modeled with the goal of obtaining a satisfactory resolution.

2.4.9 DB Analysis Tool

While the presence of some types of fields can definitively allow linkage to an individual's identity, the ability to link a given data set to a unique individual is not necessarily binary. For example, a 9-digit zip code and date of birth together have a high-probability of yielding someone's identity, whereas a 9-digit zip code and only a year of birth have a yield a lower probability.

2.5 PRML

The PRML language specification describes the Privacy Rights Markup language. This language describes how data can be accessed and how it should be transformed given attributes of the request/requestor, such as role, purpose, and operation applied on the data. PRML controls the behavior of components and provides a unified interface which to create privacy management tools which are able to interface automatically with privacy enabling components.

The PRML will now be described in detail below.

2.5.1 Introduction

In order to simplify the formalization of privacy policies, a framework of generic PRML objects and declarations is specified. The PRML declaration framework can be used in order to accelerate the creation of a new PRML policy. It can also be used as a set of guidelines to help to develop a new privacy policy.

2.5.1.1 Capabilities

2.5.1.1.1 Rights Management

The language allows an organization to formalize its privacy policies. PRML enables an application to create declarations that may be offered to the PII owner for the purpose of giving consent. The language shall also allow the specification of policies around altering privacy policies themselves. For example PRML document may specify that a notice must follow any change to the privacy policy. The notice must be sent to all individuals who have agreed with the previous privacy policy.

2.5.1.1.2 Reporting Accountability

PRML should allow one to express the necessary information about what operations are performed by whom and why.

2.5.1.1.3 Rights Interpretation

Objects such as operation, purpose and role are organized in hierarchies. These hierarchies are defined in Object Dictionary. A single declaration may be expanded into a set of declarations. PRML shall contain sufficient detail to allow expansion of high-level declarations into a set of low-level declarations. Consider the following example. PRML document defines role hierarchy when the role ‘doctor’ has two children roles ‘general-practitioner’ and ‘er-doctor’. A rule stating that a doctor can update patient profile can be expanded into two declarations: ‘general practitioner can update patient's record’ and ‘ER doctor can update patient’s record.

2.5.1.1.4 Document Extension

A PRML document may not contain the full set of declarations or objects. A mechanism for document extension shall be provided.

2.5.1.2 Examples

An example of personal record is a medical record containing patient's name, address and medical condition. An example of operation on personal record is “view”, “update” or “delete”. An example of purpose of operation is “providing care” or “targeted marketing”. An example of role is “practicing physician” or “data-mining company”. A declaration is a way of saying “I allow my physician to view and update my medical record for the purpose of providing care. I also allow the hospital administrator to see my address for the purpose of billing”.

2.5.1.3 Terminology and Documentation Conventions

The terminology used for identification of language constructs comes from in part from the domain of Fair Information Practices. Terms such as ‘dataschema’ and ‘data schema syntax’ are borrowed form P3P (platform for privacy preferences).

2.5.2 Technical Overview

2.5.2.1 Unified Modeling Language (UML) Usage

The objects and attributes of a PRML policy document are described in this specification with Unified Modeling Language (UML) static object model diagrams. The UML object diagrams capture the information and relationships, which are then represented in XML format according to the PRML Document Type Definition (DTD) files. UML class diagrams capture the object types (classes), their attributes, the attribute types, and relationships between classes.

Inheritance relationships show how one object class (subclass) extends another object class (superclass) to contain both the data of the superclass and add additional attributes. For instance, PRML makes extensive use of the concept of mixing classes. A mixing class is one having orthogonal functionality to any other class such that its attributes and properties can simply be added to a derived class in order to add a well defined facet of functionality to the derived class. For example, almost all PRML constructs represent instances of Identifiable object. Also, PRML allows operations, purposes, and roles to each form their own hierarchy of extension. The object model represents this by each of them inheriting from an ExtendsSingle or ExtendsMultiple base.

Associations show how an object of one class references or contain other objects (of the some or of a different class). Associations have cardinality and navigation characteristics. Cardinality defines how many objects of one end of the association are associated with how many objects on the other end of the association. Cardinality of one would denote a mandatory association to one other object. A cardinality of n . . . m would denote that an object is associated with at least n objects and at most m objects. Associations also indicate navigation direction. Please note that this information reflects the expression syntax of the language but is not necessarily indicative of the navigability of such relationships in the run-time environment in which a parsed and processed PRML document might be used. For instance, one can express in the language that a policy declaration is associated with a particular role, but not that a role is associated with a particular declaration. This dichotomy of expression exists both for economy or expression and to avoid redundancy. For this particular example, a PRML compiler or processing engine, in building the run-time model of the policy, can construct a bidirectional relationship; it does not need to be expressed directly in the language as the tools can automatically infer it.

2.5.2.2 UML to XML Mapping

PRML is an XML application. Currently, the XML representation is defined in XML DTD files. Some validation and data type knowledge that can be expressed in an XML Schema may be lost in the DTD representation. The XML representation is generated from the UML drawings according to a set of rules.

Firstly, a set of primitive data types is defined to indicate how #PCDATA values should be constrained to match the XML Schema data types. Some of these are the built-in datatypes defined by the XML Scheme Datatypes standard. Others are PRML definitions of new XML Scheme generated data types. The intent of the constraints imposed by each data type is documented in this specification, or, in many cases, other standards are referenced. The XML 1.0 DTD cannot express the data type constraint; instead, the data type is merely represented with a parameter entity reference. For example:

<!-- Primitive Types: they match the XML Scheme Data Types -->

<!ENTITY % timeInstant “#PCDATA”>

A class may represented two parameter ENTITY definitions in the DTDs, where warranted. One ENTITY expresses the content of the class (if any), while the other ENTITY expresses programmatic attributes of the class (if any). Subclass entities include the superclass entities. Data and relationships which are core to the language concepts are expressed as the content of the relevant class and are represented by element ENTITY definitions. XML attributes, on the other hand, are used to express meta-data about the construct, or instructions to the tools, which must process the construct. Where a class has member values, they are defined following the ENTITY definitions for the contents of that class. For example:

<!-- Identifiable Mix-in Class -->
<!ENTITY % Identifiable “ oid”>

<!-- properties -->

<!ELEMENT oid (%key;)>

<!-- ExternalReference-Attr

(describes classes with meta-data telling the tool to import
data from an external resource -->

<!ENTITY % ExternalReference-Attrs “ external-ref CDATA

#IMPLIED”>

<!-- Role Classes -->
<!ENTITY % Role-Set “ role*”>
<!ENTITY % Role-Set-Attrs “ %ExternalReference-Attrs;, ...”>
<!ELEMENT role-set (%Role-Set;)>
<!ATTLIST role-set (%Role-Set_Attrs)>
<!ENTITY % Role “ %Identifiable;, ...”>
<!ELEMENT role (%Role;)>

2.5.2.3 PRML Document Structure

PRML is Privacy Rights Modeling Language is a language describes the relationship between:

personal record

operation

purpose of operation

role

The above relationship is called declaration. Declarations are used to express privacy rights of owners and other actors involved in handling of PII. If any of the declaration if more than one declaration is applicable to a particular relationship, the operation will be allowed if at least one of the declaration allows it. In order words declarations are OR-ed together.

A typical PRML document is composed of three parts:

Object Dictionary.

The object dictionary defines objects referenced declarations. The dictionary is separated in sets. Every set contains a collection of objects of the same type (ex: operations-set). Single object can be reference by multiple declarations.

Data Schema.

Data schema section defines the data dictionary as it describes the existing data environment (database structure). The elements of data schema are referenced to create data elements for declarations. See section 5.

Declarations Set.

Declaration set includes the collection of declarations. Declarations refer to objects found in the dictionary in order to specify the relations between them.

2.5.2.4 PRML within the EPM

PRML is used to describe privacy policies for the informed release of information to authorized parties. This markup language will interact with a number of components within the privacy platform. Refer to correspondent design documents for details on architecture of components mentioned in this section.

2.5.2.5 PRML Authoring Tools

This component allows a CPO or other privacy rights administrator to easily define a PRML policy. This tool will generate a set of PRML documents, which can then be loaded into the PRML compiler and other tools. Ideally, this consists of a GUI, which manages the various PRML components, which can be created, the data schema, and the links between them. An authoring tool can also be as simple as an XML editor, which is working with the PRML DTD.

2.5.2.5.1 PRML Compiler

The PRML Compiler takes a PRML policy and assorted files and expands it to a set of privacy rights meta-data. This information will enumerate all possible rules, which can be applied to data given the various roles, purposes, and declarations. This meta data is then further converted to a set of information, which the legacy database can use to implement the privacy policy in the case where the PRM is actually implemented by the legacy database system. It can also be further converted to data used by a standalone PRM in the case where the PRM is a separate component, which is contacted by a legacy database system.

2.5.2.5.2 PRML Conversion Tools

The conversion tools allow a set of PRML components to be expressed in different representation formats. Two immediate tools which can be built around the PRML compiler are:

PRML2P3P: This tool expresses the PRML policy as a set of P3P files. There will be some information lost since PRML has a wider range of concepts that it can express.

PRML2natlang: When properly designed, PRML files can be processed to generate a natural language description of the policy. This tool takes a PRML file and creates this description.

The above tools are based on XSLT templates. PRML's structure allows to create other XSLT templates to convert a PRML document in to a document in other format.

2.5.2.5.3 Privacy Rights Manager (PRM)

This component uses the data generated by the PRML compiler to decide whether or not information is released to a query.

2.5.2.5.4 Relationship Management

Relationship management requires that long term relationship between users, owners, and specific roles be identified and kept up to date. This can be a fairly complex problem and is dependent on an application/entity to be able to keep track of this information accurately. An example of this it the PERSONAL-PHYSICIAN role. Every doctor is a personal-physician and every patient has a personal-physician, however the relationship management system must be able to link a specific patient to a specific doctor for this role in order to properly apply the privacy rules, which refer to this role.

2.5.2.5.5 Consent Management

Consent management requires a new data path, which allows information owners to consent to specific declarations stated in the PRML privacy policy.

2.5.2.5.6 Authentication System

The authentication system database must be augmented with the roles, purposes, and operations, which can be assigned to specific users of the application.

2.5.3 Object Dictionary

This section describes the contents of object dictionary section of PRML file.

The purpose of object dictionary is to define all objects that make up declarations. The dictionary includes collections for:

roles

operations

purposes

data elements

constraints

Every collection may refer to the external prml file. Roles, operations and purposes create correspondent ontology. An object within ontology extends another object higher in the ontology. For example operation ‘send email’ extends operation ‘read email address’.

Every object in object dictionary has object ID (oid). The OID is used in order to reference the object from the declaration. It is also used in order to specify the extended object to create ontology of objects.

The ID should be unique within the system. A PRML document may import whole or parts of object dictionary from a different file. This allows for creation of multiple sets of declarations based on the same object dictionary.

The static diagram of headers is shown in FIG. 4.

2.5.4 Privacy Declarations

Privacy declaration creates a relationships between objects from different collections in the dictionary. Every declaration must specify one of from each collection. The static diagram of rules is shown in FIG. 5.

2.5.5 Data References

2.5.5.1 PRML Data Definition

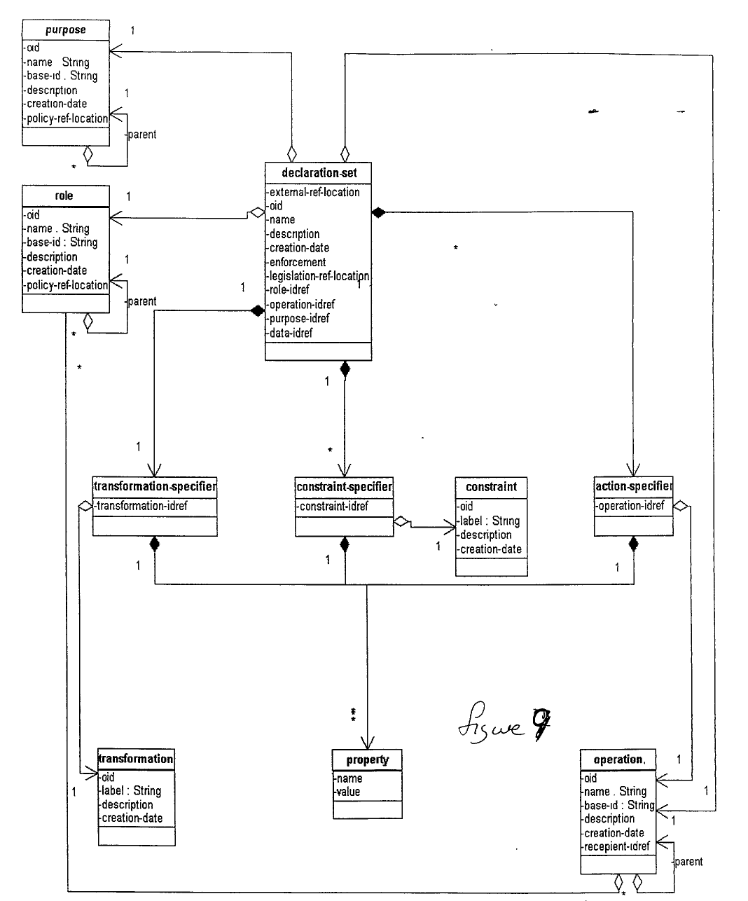

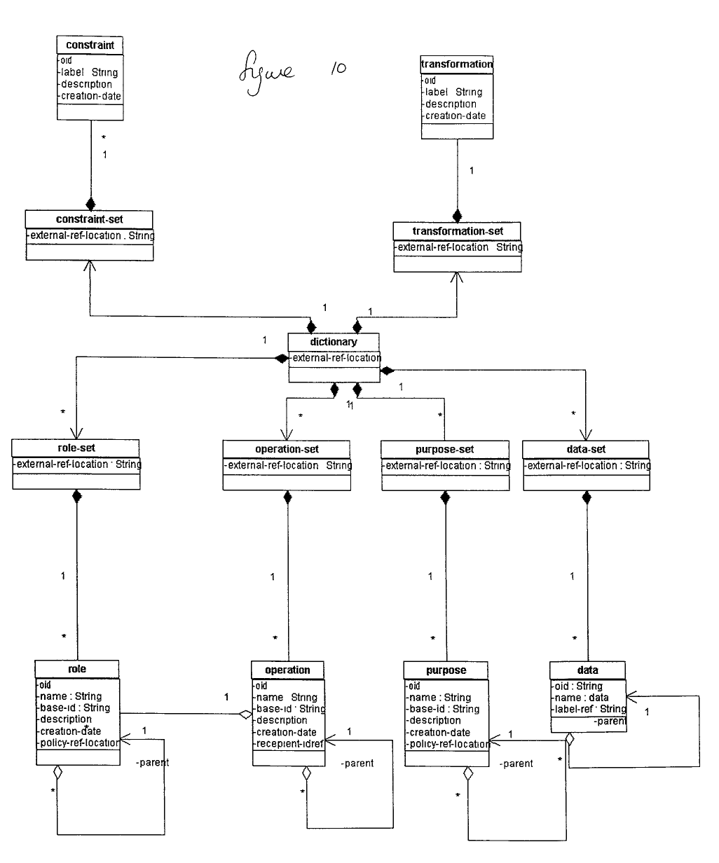

A UML statue structure diagram of a document is shown in FIG. 6, a declaration in FIG. 7 and a dictionary in FIG. 8. PRML data definitions consist of the following types of elements:

data-set This is a set of data items to which a particular PRML declaration applies. Data-sets contain one or more data items. Each <data-set> element must have an oid. This can be referred to within a declaration using a <data-set-id> element.

data This is a reference to a specific data record type. These refer to local or remote data-defs.

data-def A data-def optionally links a data record name to a structure definition which describes the record. If there is no link, the data record type exists but its description is unavailable or unused by the PRML policy.

data-struct A data-struct describes the columns which make up a data record.

Each data struct can optionally point to other local or remote data-structs to further refine the description of the record.

A PRML declaration will identify the record types to which it applies by specifying a <data-set-id> element, which refers to a <data-set>. This allows multiple declarations to refer to the same set of data-record. The <data-set> elements can include the import=URI attribute which will indicate that the specified record types are described in a <data-schema> element of the referenced document. Data-schemas should always be defined in a separate file, so this attribute should always be present. If it is not present, the PRML compiler will assume that the PRML document contains a <data-schema> that describes the <data> items. There can be one <data-set-id> per declaration.

Each <data-set> contains one or more <data> elements. Each <data> element must contain a <name> element which refers to a <data-def> or <data-struct> within the <data-schema>.

The <name> element as applied to the data definition has a special use beyond the normal one for PRML; it is used to link the data definitions and data structures together. Data definitions and structures are named according to a namespace convention which seperates parent objects by periods (“.”) There are two reasons for this. It allows the names to map to a database system namespace and it allows an object to identify its children. This allows the data-schemas to refer to other data-schema documents. Examples:

vehicle.model

vehicle.year

vehicle.manufacturer.location

vehicle.manufacturer.company

When making reference to a <data-def> or <data-struct> which is contained in the document, you must use the URI convention of placing a hash (‘#’) character in front of the name. This character does not appear in the <name> element.

The <data-def> elements list all of the record types, which can exist under a particular schema. Each of these can optionally have their structure described through links to <data-struct> elements.

The <data-struct> elements describe the structure of various types of data record. Note that different data record types (as identified by the various <data-def> elements) can actually have the same structure simply by pointing to the same <data-struct> root. Each <data-struct> can optionally point to a local or remote <data-struct> that further defines the structure.

The <data-def> and <data-struct> elements do not contain real data. They only describe the structure of the data records to which the PRML policies apply. In most cases it will not be nescessary to completely describe a data record beyond the name, which is need to identify it in the database.

2.5.5.1.1 Examples

This example shows how the various data reference and definition elements are put together to allow a PRML policy file to refer to data records. The following might be included inside a PRML declaration to identify the record types to which it applies. In this case, the records involved are “medical-history” and “insurance-coverage”. These will be described in the <data-schema> section of the file “data-def.xml”.

<declaration>

<data-set-id>DS0001</data-set-id>

</declaration>

<data-set import=“data-def.xml”>

<oid>DS₀₀₀₁</oid>

<data><name>#medical-history</name></data>

<data><name>#insurance-coverage</name></data>

</data-set>

The “data-def.xml” file contains a <data-schema>section as follows:

<data-schema>

<data-def>

<name>insurance-coverage</name>

</data-def>

<data-def>

<name>medical-history</name>

<description>Lists known conditions and diagnoses</description>

<data-struct-ref>#med-cond</data-struct-ref>

</data-def>

<data-struct>

<name>med-cond.condition</name>

<description>A chronic or recurring illness or condition</description>

</data-struct>

<data-struct>

<name>med-cont.incident</name>

<description>A one time illness or injury</description>

</data-struct>

<data-struct>

<name>med-cond.doctor-notes</name>

<data-struct-ref>http://someplace.com/schema#diagnosis</data-struct-ref>

</data-struct>

</data-schema>

This schema defines two types of records, “insurance-coverage”, and “medical-history”. Since “insurance-coverage” does not have a <data-struct-ref> element, it is not further described and its structure is unknown for the purposes of the PRML policy. The “medical-condition” definition however, points to the “med-cond” data structures. This allows us to see the structure of a “medical-condition” record. All <data-structs> whose <name> elements contain the prefix “med-cond” belong to this record. In the case of “med-cond.doctor-notes”, there is an additional description available, however it must be obtained from the file “schema”, stored on the site “someplace.com”. The “schema” file must contain <data-schema> which has one or more <data-struct>s with the prefic “diagnosis”. An example of what this file might contain:

<data-schema>

<data-struct>

<name>diagnosis.doctor</name>

<description>ldentity of doctor making diagnosis</description>

</data-struct>

<data-struct>

<name>opinion</name>

<description>The doctor's diagnosis</description>

<data-struct>

<name>treatment</name>

<description>The doctor's suggested treatment</description>

</data-struct>

</data-schema>

When taken together, the <declaration>in the original PRML policy file applies to two record types, “medial-history” and “insurance-coverage”. The “insurance-coverage” record type is not further described, however, the medical history record type has the following structure defined through two data-schemas:

medical-history.condition

medical-history.illness

medical-history.doctor-notes.doctor

medical-history.doctor-notes.opinion

medical-history.doctor-notes.treatment

Any of these names or prefices can be referenced by a <data> element in the <data-set> of a <declaration>. The above declaration could therefore also reference items such as:

<data><name>medical-history.doctor-notes</name></data> or

<data><name>medical-history.illness</data>

2.5.5.1.2 Converting a PRML Data-Schema to P3P

The PRML data reference and definition mechanism is strongly influenced by the one used by P3P. The following guidelines are provided to indicate the relationship and to assist in conversion from one to the other.

PRML data definitions provide a name and an optional description. There is no “short-description” attribute, which can be specified so these are never generated when converting to a P3P data schema.

P3P defines an attribute “optional” for its DATA element while PRML does not. This attribute indicates whether or not a visitor to a site can withhold the specified piece of data. If not specified, it is set to “no”. When converting from PRML to P3P, this value should be explicitly set to “no”. Since PRML deals with releasing data rather than collecting it, a visitor to the site should be obliged to provide it. This should be examined further however.

PRML does not define data categories. P3P attaches categories to DATA, DATA-DEF and or DATA-STRUCT elements in order to provide a hint regarding the intended use of the data. This must be specified somewhere inside a P3P data schema. How to do this from PRML is still an open issue, but one approach may be to use P3P's extension mechanism and assign the following for each DATA-DEF:

<CATEGORY><other-category>PRMLDataSchema</othercategory></CATEGORIES>

The <data-set> element maps directly to DATA-GROUP. <data-set> can specify an “import” attribute. This also maps directly to “base”. It is assumed that the PRML data-schema will always be in a separate file. In this case, the link to that file will be identified through a “base” attribute specified for the <DATA-GROUP> element. If the PRML data-schema is exported to the P3P file itself, the “base” attribute value must be set to the empty string (“ ”).

When converting PRML <data> to P3P<DATA>, the <name> element must be converted to the attribute “ref”.

The <data-def> element maps to P3P's <DATA-DEF>. The <name> element becomes the “name” attribute and is transferred as is. The same thing is done for the <struct-ref> element; it becomes the “structref” parameter. There is no equivalent to the “short-description” attribute. Since this is optional in P3P, the conversion process does not specify it.

The PRML <data-struct> elements map to P3P's <DATA-STRUCT> and are treated the same way as <data-def>.

Within PRML data definitions, instances of <description> elements become <LONG-DESCRIPTION> when transferred to P3P data schemas.

2.5.6 Base Declarations

A certain number of declarations shall be present in any privacy policy that is to adhere to Fair Information Practices. This section defines such declaration in a general case.

The specification of a language without usage guidelines is difficult to use. The base declarations along with base objects create a framework for development of richer and customized declarations. The indented usage of the declarations in this section is to provide a starting point for privacy office and integrator to create specific corporate privacy policy.

2.5.6.1 Owner Access

The PII owner shall be able to access its personal data.

The PII owner shall be able to view the access log.

2.5.6.2 Notice of Policy Amendments

When a declaration is amended, all individuals that have consented to this declaration must be notified.

2.5.7 PRML Document Examples

The following examples are based on hypothetical, but non-trivial privacy policies. Note that every privacy policy and correspondent PRML document should be considered as fragments of a comprehensive set of policies.

2.5.7.1 Basic Declarations

As specified earlier, every privacy policy should include some basic declarations in relation to the fair information practices.

2.5.7.2 Events and Properties

The following statement may be encoded in the PRML document:

This e-mail address may be used for correspondence regarding transaction number 1234 only, and is to be purged when transaction number 1234 is complete. In no case may this information be retained after date D.

2.5.7.3 More Events and Properties

The following statement may be encoded in the PRML document:

This e-mail address may be used for correspondence regarding transaction number 1234, or for product recalls or other reports of serious safety or security issues regarding product X as purchased in transaction number 1234. The address is to be purged when product X is declared obsolete.

2.5.7.4 Extending Purpose Object

The following statement may be encoded in the PRML document:

This postal address may be used by corporation X to advertise products falling under SIC code blah.

2.5.7.5 Multiple Declarations, Data Groups

The following statement may be encoded in the PRML document:

This name, patient room number, diagnosis code, physician's notes, and attached medical imaging may be provided to licensed health care professionals at hospital X for the purposes of treating the named patient. Authorization is not granted for access to the patient's billing information.

This diagnosis code, physician's diagnostic note, and list of provided

treatments may be used by designated claims adjusters for companies in group foo, for evaluation of medical insurance claim number 69, provided that no PII is provided to the adjuster in a way that can be linked to this diagnosis code.

This name, address, and authorized claim amount may be provided to

designated check issuers for companies in group foo, provided that no medical diagnostic information is disclosed to the check issuer. Information on claims paid is to be purged on date D.

2.5.7.6 Transformation Setting for Write Operation

The following statement may be encoded in the PRML document:

This biometric information (which is to be stored only in hashed form), may be used by authentication service X for the purpose of validating access to Web sites certified by privacy auditor Y.

2.5.7.7 More Transformation Settings

The following statement may be encoded in the PRML document:

This survey response may be used for political advocacy when statistically aggregated with all other responses to this survey question.

2.5.7.8 Some More Transformation Settings

The following statement may be encoded in the PRML document:

This survey response may be used for political advocacy when statistically aggregated with all other responses to this survey question.

2.5.8 Relationship to Other Standards

2.6 Use of the EPM

The following provides various scenarios in which the EPM system is used.

2.6.1 Customer Refuses Use of His or Her Personal Data.

Assume that a user, Alice, learns from news reports that personal information about her is being used in ways she doesn't approve. She goes to the company's web site, and attempts to change it. She reaches a consent module, which asks her to login. The consent server passes her request on to the access control server to ensure that she is able to login.

Next, the consent server presents a web page welcoming her. Meanwhile, the consent server makes a request to the access control server to find out the type of customer Alice is, and the preferences she is allowed to set. It obtains this information by parsing a PRML file, to extract the policies that apply to Alice. Her allowed choices are presented to her in some friendly way, allowing her to make choices. Once she has made (and perhaps confirmed) choices, the new preferences are bundled up and sent back to the corporate access control server, to be stored there for any applications which is privacy-enabled.

Some time later Alice goes to the company's web site, and attempts to change her preferences. She reaches a web server which is running a consent module. The consent module is a web application, coded in a mix of static and active web pages, along with several CGIs. The first pages reached are the login pages, which are a standard login module from the access control vendor, with local content, stylesheets, and other user interface components. The access control module sends the request (perhaps username and password, perhaps something stronger) via SOAP to the access control server (ACS) to ensure that she is able to login. Assuming that the ACS server approves it, the consent server presents a web page welcoming her. That page was created by the local web services team.

Meanwhile, the consent server is making a request to the ACS to find out what type of customer Alice is, and what preferences she is allowed to set. This request will likely have a packaged answer:

There are only a few customer types, and a few preferences for each. As such, it has been precomputed by batch processes on the ACS. That batch process will have been built from a ZKS supplied skeleton, modified by the customer to fit their customer types list. The ACS will also have looked up in its database what preferences Alice has set in the past, and will bundle these into the answer. The consent server will then take this data, and present it to Alice, allowing her to review and perhaps change her preferences. Once she has made choices, the validity of those choices is checked by the system, and new preferences are bundled up and sent back to the ACS. On the ACS, they are unbundled and placed in the access control database.

2.6.2 Distribution and Use of PRML Policies

Once a policy has been created, it needs to be made available to the various services that need it. There are varying levels of directness to this process. We will examine both distribution of the files, and of their contents. We will start with the simplest, and go to a more complex. Some of the distribution methods involve sending around the entire PRML file to where it is needed; others involve an access control server providing access to the file or portions thereof.

The simplest distribution mechanism would involve use of a PRML file on a shared file system, such as SMB or NFS, so that all processes can see the same file. Only slightly more complex would be use of a web server, with the PRML file at a standard URL that could be fetched from time to time. More advanced distribution schemes would involve the use of LDAP (Lightweight Directory Access Protocol), SOAP (Simple Object Access Protocol), or the extension of native formats, such as SQL, to include PRML extensions.

Those methods that involve moving the entire PRML file require some parsing code where the file is to be used, however, the mechanics of moving the file are simple. Those methods that move the PRML to an require that the parsing code be integrated into the ACS, however, the end system remains unchanged.

The many distribution methods which are needed to support today's applications are, for our purposes, reducable to one of two cases: They provide the PRML, or they use PRML to make a decision which is passed over some other protocol.

We examine the case of a database with an integrated PRML policy engine, and the integration of PRML into a corporate ACS. We assume that each has an up-to-date PRML policy file.

Our components are: A database with a large amount of personal information stored within; a policy enforcement engine; a PRML file; the computer on which the previous three components are hosted, and a number of database clients.

For efficiency reasons, the first three may well be stored or cached on the same computer. The policy engine will read and then parse the PRML file. It will internally convert the policy from the original XML to a format designed to allow it to make fast decisions about requests. Such a format would likely be a binary format indexed according to the table or row of the database being accessed, along with the other decision criteria, organized such that all the data for a database cell fits into cache memory.

When a request comes in from an unmodified database client, the policy engine will examine it, and make an allow/deny decision. This represents a balancing of the desire to not modify infrastructure components, but to enforce policy decisions.

However, allow/deny may not be the best decision set possible; if the clients are more flexbile, it may be possible to pass back a range, or a generic form of some data, such that the request is answered without exposing the exact data. For example, rather than responding to a salary request with the number 23,600, the database could pass the data through an aggregation layer, and return a value indicating a range of 20,000-30,000, or perhaps the client will query and ask “Is income greater than 25,000?” It is likely that the decision that needs to be made can be made with the less precise data; the more modifications that can be made to the client code, the more flexibility is available. Functionality of de-identification, etc, is available to comply with constraints expressed within PRML.

2.6.3 Building a Policy Model

Building a policy model means defining elements and creating statements from the templates. The following guidelines should be considered when building a policy model in EPM.

Choosing an approach

Documenting intent

Being consistent

Modeling consent

Modeling Personal Information (PI)

Scoping statements

Using filters

Resolving conflicts

Choosing an Approach

There are two approaches to building a policy model:

A top-down approach

A bottom-up approach

In the top-down approach, statements are created first, and elements are created as necessary to complete the statements. In the bottom-up approach, elements are created first and linked together in statements afterwards. Both approaches are useful. You may switch from one approach to the other in the midst of creating a policy model. The element/child relations tend to be easier to manage using the bottom-up approach. Creating elements with the necessary detail to model the privacy policy and data-handling practices is more obvious with the top-down approach.

Modeling Consent

Consent is an important concept in privacy management. Providers of data are often asked to consent to using their data for various purposes. This consent is collected and stored. When using that data, storing that data, or disclosing that data to a third party, the terms of the consent must be respected.

EPM allows the user to model consent with a Condition element. For example, ABC Bank may disclose customer phone number to ABC Marketing Department for offering new services if customer has consented to ABC Bank offering new service by telephone. It is often necessary to specify detailed conditions to differentiate one type of consent from another.

Conditions are not evaluated as true or false in EPM, but they are used to render opinions on pairs of related statements.

Modeling Personal Information

Personal Information (PI) is another important concept in privacy management. PI is any data that is linked to identifying data. For example, a salary figure is harmless, but that figure becomes sensitive PI once linked to a name or some other identifying data. The handling of PI is modeled in EPM with data-combination principles. The above association between salary and name can be modeled as

Salary may not be used together with name or telephone number or address.

Scoping Statements

The scope of a statement is determined by its constituent elements. A statement has minimal scope if it contains only elements without children. If children are added to an element of a statement, then the scope of that statement is increased. The scope may also be increased by adding multiple elements to any of the statement's slots. For the sake of analysis, each of the elements in a single slot is related with a logical “or”, except for conditions, which are related by a logical “and”.

Two statements have overlapping scope if they apply to the same element in each slot that appears in both statements. The same privacy policy and data-handling practices may be modeled by many statements with narrow scope or by fewer statements, each with a broad scope. Policies with few broad statements tend to be easier to maintain, but they also have many complex relations among the statements and their exceptions.

Using Filters

A filter may be applied to an element in a statement to reduce the scope of that statement. The statement's scope then includes that element and the children of that element which satisfy all the criteria of the filter. A criterion is whether or not a particular property of an element includes a particular piece of text.

Resolving Conflicts and Violations

Contradictions among statements in a policy model take the form of conflicts and violations. A conflict is caused by a pair of practices or a pair of principles with opposite polarity and overlapping scope. A violation occurs if a practice and a principle have opposite polarity and overlapping scope. An example of two statements in conflict is as follows:

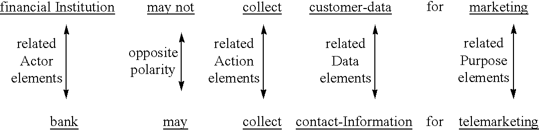

Conflicts can be resolved by:

Eliminating overlapping scope

Using exceptions

Assigning precedence.

Eliminating Overlapping Scope

The most direct method of resolving a conflict or a violation is to eliminate the overlapping scope by removing the elements common to both statements in any slot from the statement of lower precedence. If the overlap in scope results from a child of an element, then the overlapping scope may be eliminated by replacing the element with all its children except that child which is in conflict or violation.

For example, suppose that marketing is an element of type purpose and it contains as children telemarketing, e-mail marketing and other marketing. The conflict could be resolved by changing the first statement to Financial institution may not collect customer-data for e-mail marketing and other marketing. Eliminating the overlapping scope for any single slot of the statement will resolve the conflict or violation.

Using Exceptions

Exceptions are another method of eliminating conflicts and violations by overriding all or part of the analysis results concerning the exception's parent statement. A statement that is tagged as an exception of another statement applies solely to the scope of the statement to which it is an exception of.

Assigning Precedence

The third method of eliminating conflicts and violations is the explicit assignment of precedence between the two conflicting statements with a Precedence statement. One statement is designated to have higher precedence than a second statement. For example, in the above example the conflict can be resolved by creating the precedence statement that gives the second statement higher precedence than the first statement.

Analysis

Analysis can reveal how statements are related to one another. The analysis generates results according to the analysis logic. The analysis results are based on the relationships among elements and statements.

Analysis Logic

The analysis logic compares pairs of related statements and generates an analysis result on that pair. The particular analysis opinion depends on

the types of statements being compared

whether the polarity of the statements is the same or opposite

the condition elements of the related statements

The following table shows the opinion that is generated depending on the statement types and their polarity. The order of the statement is not significant. The Effects of Conditions on Analysis are addressed later.

[image]

The analysis logic summarizes the analysis results for each statement. Each statement may have up to two summaries of analysis results. One summarizes all of the analysis results with statements of the same type as follows.

Analysis Summary for a Statement and all Like Statements

[image]

Another summarizes all of the analysis results with statements of a different type as follows. Note that the neutral results have no effect.

Analysis Summary for a Statement and all Unlike Statements

[image]

The Statements view displays the analysis results associated with the currently selected statement. The Analysis report displays all analysis results.

Related Statements

The analysis generates results for related statements only. A statement cannot be related to itself, but any two statements may be related. Statements are related if and only if they contain a related Actor, Action, Data and Purpose element. Two elements are related if

The happen to be the same element

One element is a child of the other, or

Both elements share a common child

Consider the following example with statements that contain Disclose elements.

Statement-1: Bank may not disclose to/with/or customer data for marketing if customer has opted out of marketing from recipients. The data provider(s) is/are provider. The data recipient(s) is/are affiliates.

Statement-2: Credit card company does disclose to/with/customer first name and customer e-mail address for sales follow-up. The data provider(s) is/are provider. The data recipient (s) is/are customer support department

So Statement-1 and Statement-2 are related if and only if

Bank is related to Credit card company;

disclose to affiliates is related to disclose to customer support department;

customer data is related to customer first name OR customer e-mail address;

affiliates is related to customer support department AND

marketing is related to sales follow-up.

If multiple elements are contained in a slot, as is the case for the data slot above, then a relation between either of the elements is sufficient. In general, the contents of slots with different names are not compared to determine if statements are related. An exception to this general rule occurs with statements derived from the Data Combination template, in which case the data-1 slot and data-2 slot are compared to all slots in the other statements that may contain Data elements. For example, consider Statement-3.

Statement-3: Customer name may not be used together with customer e-mail address.

Statement-1 and Statement-3 are related if and only if

customer data is related to customer name; AND

customer data is related to customer e-mail address.

Statement-2 and Statement-3 are related if and only if

customer first name OR customer e-mail address is related to customer name; AND

customer first name OR customer e-mail address is related to customer e-mail address.

The statement type, polarity, conditions, and exceptions are always irrelevant to the determination of relations among statements. However, these factors do not affect the analysis results. The effects of statement type and polarity on the analysis were discussed in the previous section. The effects of conditions and exceptions are discussed in the following sections.

Effects of Conditions on Analysis

A Condition element can be attached to a practice or a principle. Condition elements are always preceded by “if” in the statement text. Condition elements are ignored when determining if a pair of like statements are related, and when generating an analysis opinion for two like statements

For example, consider the following principles.

Statement 1: ABC Bank may collect data from customers for marketing if the customer has opted in for marketing.

Statement 2: ABC Bank may not collect data from customers for marketing if the customer resides in Germany.

These two related principle statements produce a Conflict result because they have opposite polarities. The Condition elements are ignored because they could both be true at the same time. This conflict may be resolved by setting the relative importance using precedence or exceptions. See Resolving Conflicts in Building a Policy, in Chapter 8. The generation of an analysis result for a related practice and principle is affected by the presence of a Condition element. A principle is a statement that specifies the conditions under which a practice may or may not occur. A practice must contain at least one Condition element. The default is all conditions. The following table exhaustively lists all analysis results generated among six practices and eight principles, each with Actor element “A” and Action element “B”. Assume that the unmentioned Data elements and the Purpose elements are related for all twelve statements. Some statements have no Condition element, some have a Condition element named “red”, and others have a Condition element named “blue”. A blank cell indicates that no opinion is generated.

[image]

Exceptions have two effects on the analysis. Firstly, a statement and its exceptions do not generate an analysis result even if that statement and its exception are related. Secondly, an exception only affects the analysis results within the scope of its parent statement. Therefore, the analysis assumes that an exception inherits all Condition elements from its parent. In addition, an exception may have a broader scope than its parent, but the analysis implicitly curbs the scope of the exception, such that the scope is bounded by that of its parent, its parent's parents, etc.

For example, Statement 2 can be used as an exception to Statement 1

Statement 1. Bank may not disclose customer data for marketing if customer has opted out. The data recipients are affiliates.

Statement 2. Financial institution may disclose customer data for marketing if customer is overseas. The data recipients are overseas affiliates

In this example, statement 2 inherits the condition if customer has opted out from Statement 1. Assuming that Bank is a child of Financial institution, Statement 2 only applies to the Bank actor element and its children Under these circumstances, Statement 2 will override Statement 1.

2.7 Summary

Although the invention has been described with reference to certain specific embodiments, various modifications thereof will be apparent to those skilled in the art without departing from the spirit and scope of the invention as outlined in the claims appended hereto.

The embodiments of the invention in which an exclusive property or privilege is claimed are defined as follows:

1. A method for creating a structured privacy policy said method comprising the steps of:
a) accessing a database containing data to be privatized;
b) determining for specified data how that data is to be shared;
c) generating an XML based document describing how said data is to be shared, said document defining said privacy policy.

2. An enterprise privacy system comprising:
a) a web server including a privacy policy model defining how data elements in a database is to be shared by users;
b) a privacy enforcement engine for accessing said privacy policy upon a user requesting access to data in the said database whereby, said requested data is provided to said user only upon said request conforming to said privacy policy.
